(19) United States
(12) Patent Application Publication
(10) Pub. No.: US 2026/0082704 A1
(43) Pub. Date: Mar. 19, 2026

(54) EMBEDDED POWER PICKUP IC DEVICE, LAYOUT, AND METHOD

(71) Applicant: TAIWAN SEMICONDUCTOR MANUFACTURING COMPANY, LTD., Hsinchu (TW)

(72) Inventors: Ching-Yu HUANG, Hsinchu (TW); Chun-Yen LIN, Hsinchu (TW); Wei-Cheng LIN, Hsinchu (TW); Jiann-Tyng TZENG, Hsinchu (TW)

(21) Appl. No.: 19/041,414

(22) Filed: Jan. 30, 2025

Related U.S. Application Data
(60) Provisional application No. 63/695,140, filed on Sep. 16, 2024.

(51) Int. Cl. H10D 89/10; G06F 30/392; G06F 117/04; H01L 23/528; H10D 84/01; H10D 84/85

(52) U.S. Cl. CPC H10D 89/10; H10D 84/0186; H10D 84/0188; H10D 84/85; H10W 20/427; G06F 30/392; G06F 2117/04

(57) ABSTRACT

An IC device includes two isolation structures extending in parallel in a first direction in a front side of a semiconductor substrate, a stacked CFET circuit including gates and metal-like defined (MD) segments extending in the first direction between the isolation structures. Each of the gates extends from first to second locations along the first direction and one of the MD segments is configured as a reference voltage connection of the circuit and extends from the first location to a third location further along the first direction than the second location. Frontside and backside conductive lines extend in a second direction perpendicular to the first direction, and a conductive structure extends from the frontside conductive line to the backside conductive line along a third direction perpendicular to each of the first and second directions and includes a portion of the MD segment between the second and third locations.

### PRIORITY CLAIM

The present application claims the priority of U.S. Provisional Application No. 63/695,140, filed Sep. 16, 2024, which is incorporated herein by reference in its entirety.

### BACKGROUND

The ongoing trend in miniaturizing integrated circuits (ICs) has resulted in progressively smaller devices which consume less power, yet provide more functionality at higher speeds than earlier technologies. Such miniaturization has been achieved through design and manufacturing innovations tied to increasingly strict specifications. Various electronic design automation (EDA) tools are used to generate, revise, and verify designs for semiconductor devices while ensuring that IC structure design and manufacturing specifications are met.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1A-1C are a plan view and cross-sectional views of an IC device and layout diagram, in accordance with some embodiments.

FIG. 2 is a plan view of an IC device and layout diagram, in accordance with some embodiments.

FIG. 3 is a plan view of an IC device and layout diagram, in accordance with some embodiments.

FIGS. 4A and 4B are a plan view and a cross-sectional view of an IC device and layout diagram, in accordance with some embodiments

FIG. 5 is a flowchart of a method of manufacturing an IC device, in accordance with some embodiments.

FIG. 6 is a flowchart of a method of generating an IC layout diagram, in accordance with some embodiments.

FIG. 7 is a block diagram of an IC layout diagram generation system, in accordance with some embodiments.

FIG. 8 is a block diagram of an IC manufacturing system, and an IC manufacturing flow associated therewith, in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In various embodiments, an integrated circuit (IC) device, layout diagram, and manufacturing method are directed to stacked complementary field-effect transistors (CFETs) including gates and metal-like defined (MD) segments arranged between isolation structures in an area corresponding to a cell and including one of the MD segments configured as a reference voltage connection to both frontside and backside conductive lines through an adjacent conductive structure including an interconnect structure. The interconnect structure is aligned with some or all of the gates and positioned in the area corresponding to the cell and/or in an area corresponding to an adjacent cell, e.g., an area between additional isolation structures aligned with those of the cell. In some embodiments, the stacked CFETs of the cell are configured as a clock circuit.

The adjacent conductive structure including the interconnect structure is capable of providing a low resistance reference voltage connection from the frontside and backside conductive lines to the circuit corresponding to the cell, e.g., a clock circuit, such that, compared to other approaches, e.g., those that do not include adjacent conductive structures, voltage drops based on current flow are reduced, thereby enabling higher current operations, e.g., high driving clock cell applications.

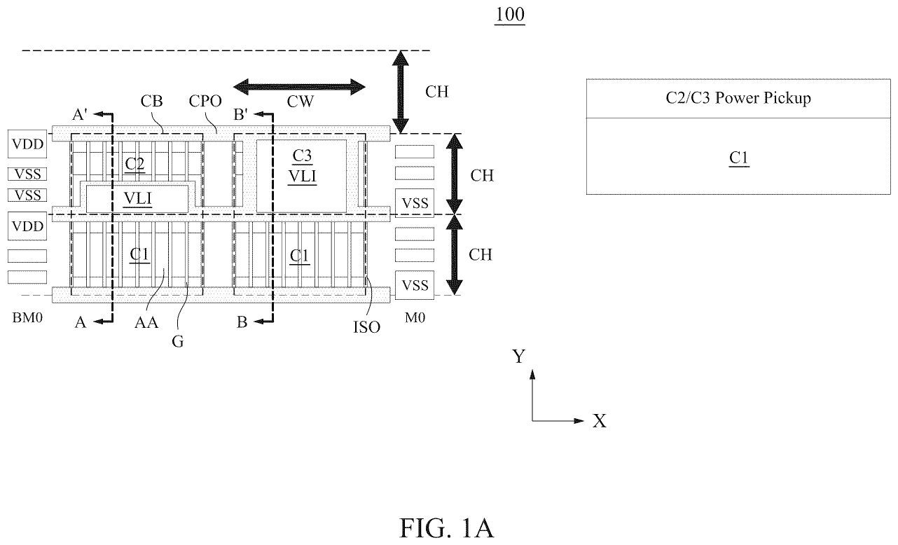

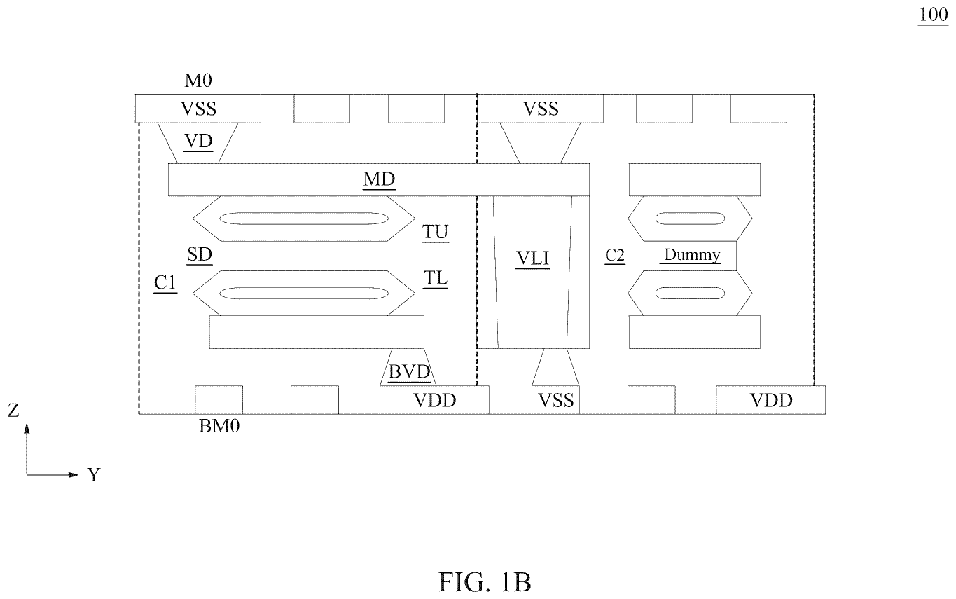

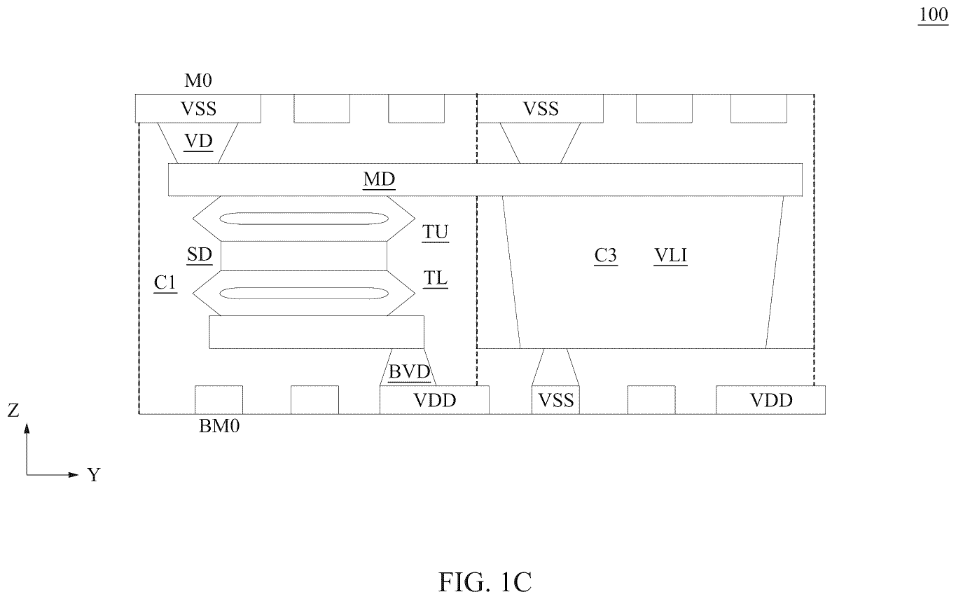

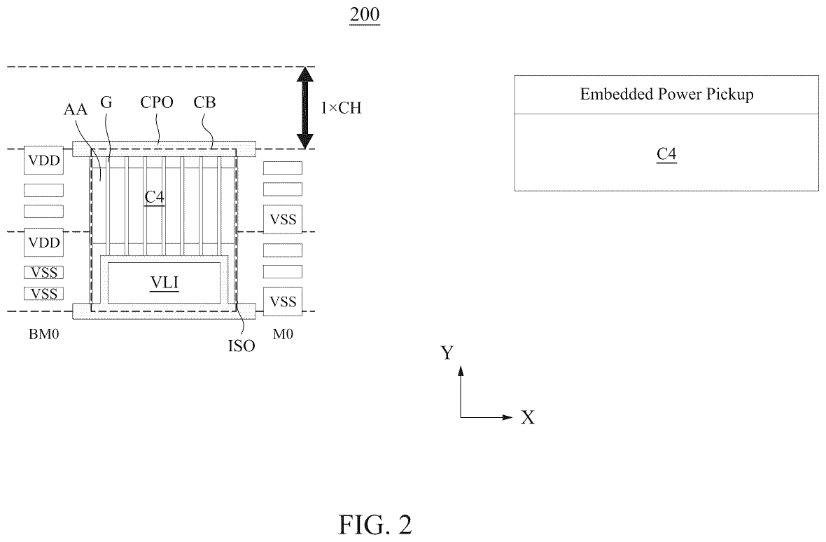

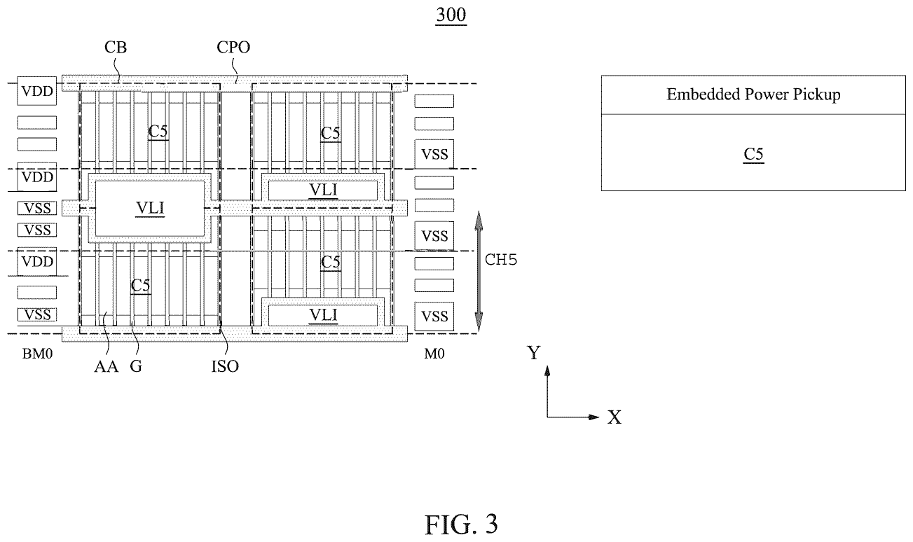

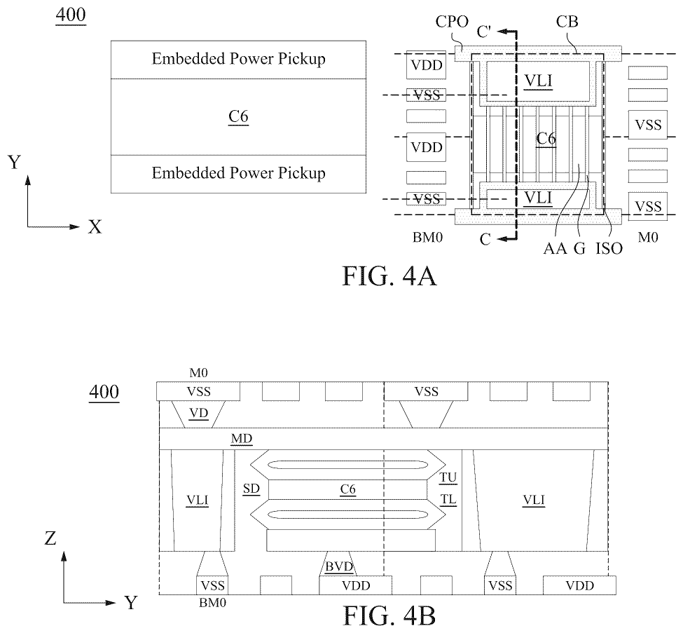

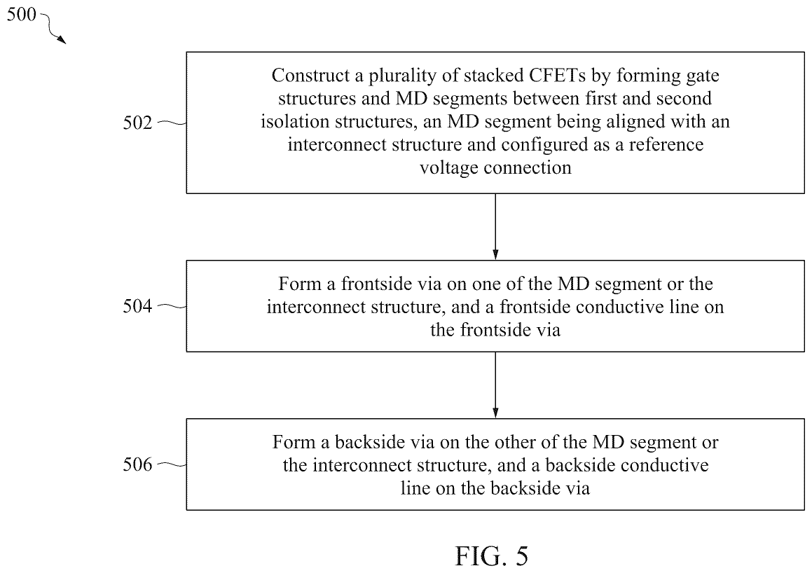

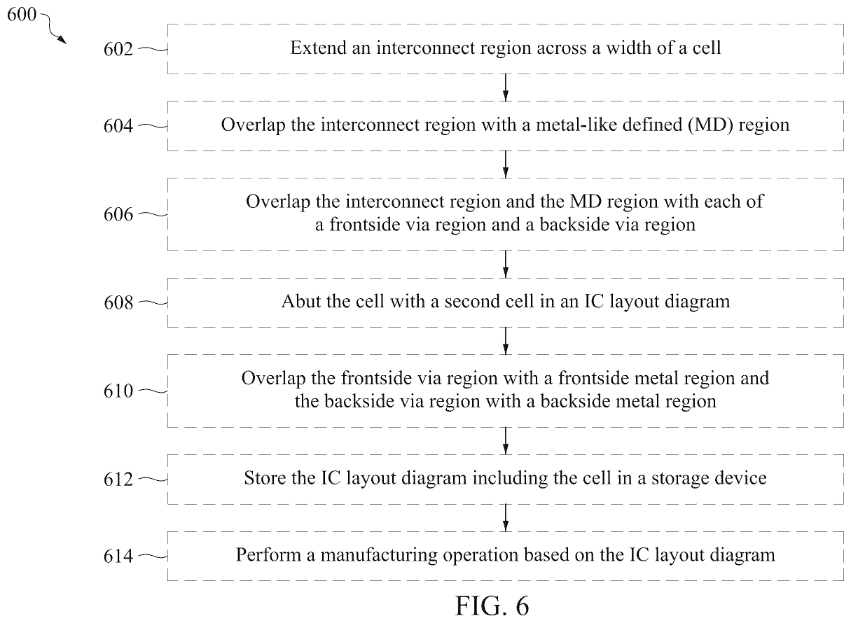

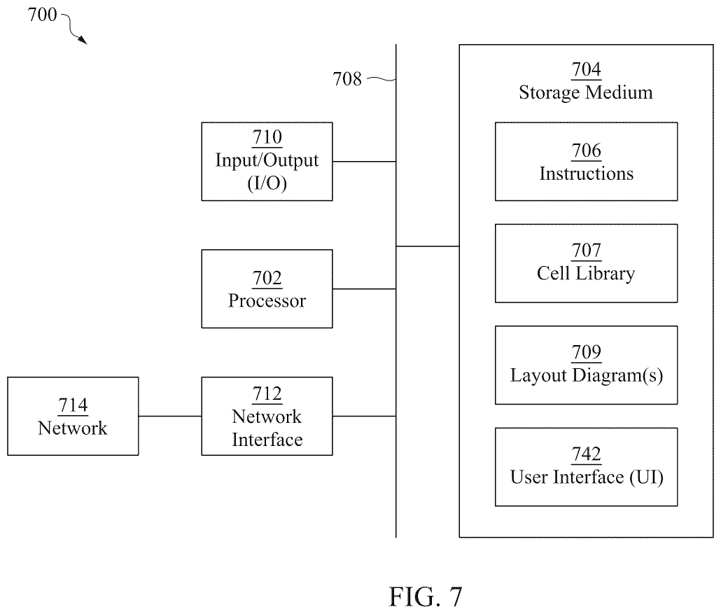

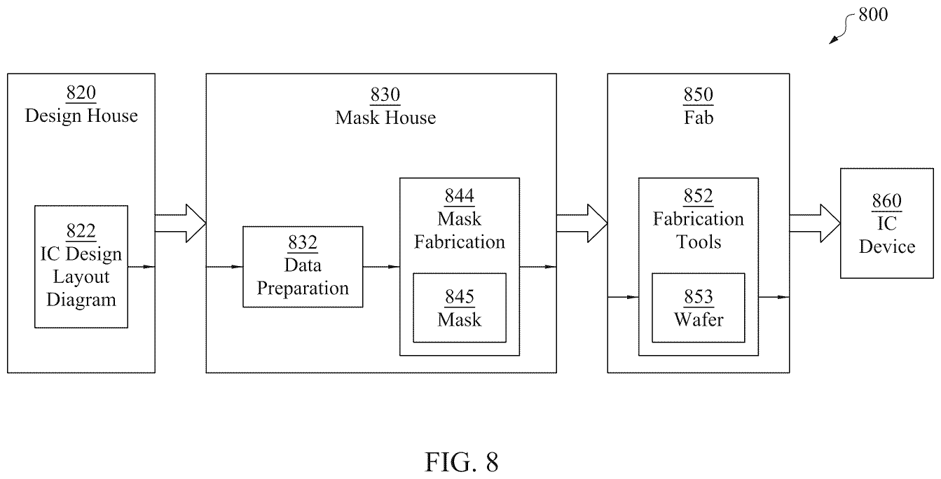

As discussed below, in accordance with various embodiments, FIGS. 1A-1C are a plan view and cross-sectional views of an IC device and layout diagram 100, FIGS. 2 and 3 are plan views of IC devices and layout diagrams 200 and 300, respectively, FIGS. 4A and 4B are a plan view and a cross-sectional view of an IC device and layout diagram 400, FIG. 5 is a flowchart of a method 500 of manufacturing an IC, and FIG. 6 is a flowchart of a method 600 of generating an IC layout diagram, e.g., using an IC layout diagram generation system 700 depicted in FIG. 7 and/or in accordance with an IC manufacturing flow 800 depicted in FIG. 8.

Each of the figures herein, e.g., FIGS. 1A-4B, is simplified for the purpose of illustration. The figures are views of IC structures, devices, and layout diagrams with various features included and excluded to facilitate the discussion below. In various embodiments, an IC structure, device and/or layout diagram includes one or more features corresponding to power distribution structures, metal interconnects, contacts, vias, gate structures, source/drain (S/D) structures, active areas, bulk connections, or other transistor elements, isolation structures, or the like, in addition to the features depicted in FIGS. 1A-4B.

In each of IC devices/layout diagrams 100-400, reference designators represent both IC device features and the IC layout features used to at least partially define the corresponding IC device features in a manufacturing process, e.g., method 500 discussed below with respect to FIG. 5 and/or the IC manufacturing flow associated with IC manufacturing system 800 discussed below with respect to FIG. 8. Accordingly, each of IC devices/layout diagrams 100-400 represents a view of both an IC layout diagram 100-400 and a corresponding IC device 100-400.

Each of IC layout diagrams/devices 100-400 and IC layout diagrams/structures 100-400 discussed below includes arrangements of some or all of at least one of a semiconductor substrate, an active region/area, a S/D region/structure, an MD region/segment, a gate region/structure, a metal region/segment, an interconnect and/or other via region/structure, and/or an isolation region/structure, each discussed below.

A semiconductor substrate, e.g., a substrate SUB, is a portion, e.g., a die, or all of a semiconductor wafer, e.g., a silicon (Si) wafer, or an epitaxial Si layer, suitable for forming one or more IC devices, e.g., IC devices 100-400. In each of the embodiments discussed below, a semiconductor substrate includes a front side within which a first subset of the features of the IC devices are formed through a first set of manufacturing processes, e.g., front-end-of-line (FEOL) processes, middle-end-of-line (MEOL) processes, and back-end-of-line (BEOL) processes, and a back side within which a second subset of the features of the IC devices are formed through a second set of manufacturing processes, e.g., backside metallization processes, performed after the first set of manufacturing processes are performed.

An active region/area, e.g., active region/area AA, is a region in an IC layout diagram included in a manufacturing process as part of defining an active area, also referred to as an oxide diffusion or definition (OD) in some embodiments, in the semiconductor substrate, either directly or in an n-well or p-well region/area, in which one or more IC device features, e.g., a S/D structure, is formed. In some embodiments, an active area is an n-type or p-type active area of a stacked complementary field-effect transistor (CFET) or another transistor configuration including a gate region/structure.

In various embodiments, an active area (structure) includes one or more of a semiconductor material, e.g., silicon (Si), silicon-germanium (SiGe), silicon-carbide (SiC), or the like, a dopant material, e.g., boron (B), aluminum (Al), phosphorous (P), arsenic (As), gallium (Ga), or another suitable material.

In some embodiments, an active region is a region in an IC layout diagram included in the manufacturing process as part of defining a nano-sheet structure, e.g., a continuous volume of one or more layers of one or more semiconductor materials having either n-type or p-type doping. In various embodiments, individual nano-sheet layers include a single monolayer or multiple monolayers of a given semiconductor material.

A S/D region/structure, e.g., S/D region/structure SD, is a region in the IC layout diagram included in the manufacturing process as part of defining a S/D structure, also referred to as a semiconductor structure in some embodiments, configured to have a doping type opposite that of the corresponding active region/area. In some embodiments, a S/D region/structure is configured to have lower resistivity than an adjacent channel feature, e.g., a portion of the corresponding active region/area of a CFET or other transistor. In some embodiments, a S/D region/structure includes one or more portions having doping concentrations greater than one or more doping concentrations present in the corresponding channel feature. In some embodiments, a S/D region/structure includes one or more epitaxial regions of a semiconductor material, e.g., Si, SiGe, and/or silicon-carbide SiC. A S/D region/structure, also referred to as a S/D terminal in some embodiments, may refer to a source or a drain, individually or collectively, dependent upon the context.

An MD region/segment, e.g., MD region/segment MD, is a conductive region in the IC layout diagram included in the manufacturing process as part of defining an MD segment, also referred to as a conductive segment or MD conductive line or trace, in and/or on the semiconductor substrate. In some embodiments, an MD region overlaps an active area at a location of a S/D region in the IC layout diagram, and the corresponding MD segment contacts and is electrically connected to the S/D structure of the active area.

In some embodiments, an MD segment includes a portion of at least one metal layer, e.g., a contact layer, overlying and contacting the substrate and having a thickness sufficiently small to enable formation of an insulation layer between the MD segment and an overlying metal layer, e.g., the first metal layer. In various embodiments, an MD segment includes one or more of copper (Cu), silver (Ag), tungsten (W), titanium (Ti), nickel (Ni), tin (Sn), aluminum (Al) or another metal or material suitable for providing a low resistance electrical connection between IC structure elements, i.e., a resistance level below a predetermined threshold corresponding to one or more tolerance levels of a resistance-based effect on circuit performance.

In various embodiments, an MD segment includes a section of the semiconductor substrate and/or an epitaxial layer having a doping level, e.g., based on an implantation process, sufficient to cause the segment to have the low resistance level. In various embodiments, a doped MD segment includes one or more dopant materials having doping concentrations of about 1*10¹⁶ per cubic centimeter (cm−3) or greater.

In some embodiments, a manufacturing process includes two MD layers, and an MD region/segment, e.g., MD region/segment MD, refers to both of the two MD layers in the manufacturing process. In some embodiments, an MD segment is configured to be electrically connected to the S/D structure of a single one of a p-type or n-type FET of a CFET, and to be electrically isolated from the S/D structure of the other of the p-type or n-type FET of the CFET. In some embodiments, an MD segment, also referred to as an MD local interconnect (MDLI), or local interconnect (LI) in some embodiments, is configured to be electrically connected to the S/D structures of both the p-type FET and the n-type FET of a CFET.

A cut-MD region is a region in the IC layout diagram included in the manufacturing process as part of defining a discontinuity in a given MD structure, e.g., a portion etched away after the MD structure has been formed, thereby resulting in adjacent and aligned MD segments electrically isolated from each other.

A gate region/structure, e.g., a gate region/structure G, also referred to as a gate G in some embodiments, is a region in the IC layout diagram included in the manufacturing process as part of defining a gate structure. A gate structure is a volume including one or more conductive segments, e.g., a gate electrode, including one or more conductive materials, e.g., polysilicon, copper (Cu), aluminum (Al), tungsten (W), cobalt (Co), ruthenium (Ru), or one or more other metals or other suitable materials, substantially surrounded by one or more insulating materials, the one or more conductive segments thereby being configured to control a voltage provided at an adjacent gate dielectric layer.

A gate dielectric layer, e.g., a gate dielectric layer of a gate structure G, is a volume including one or more insulating materials, e.g., silicon dioxide, silicon nitride (Si₃N₄), and/or one or more other suitable material such as a low-k material having a k value less than 3.8 or a high-k material having a k value greater than 3.8 or 7.0 such as aluminum oxide (Al2O₃), hafnium oxide (HfO₂), tantalum pentoxide (Ta₂O₅), or titanium oxide (TiO₂), suitable for providing a high electrical resistance between IC structure elements, i.e., a resistance level above a predetermined threshold corresponding to one or more tolerance levels of a resistance-based effect on circuit performance.

In some embodiments, a gate region/structure corresponds to a dummy gate region/structure, e.g., an isolation region/structure ISO. In some embodiments, a dummy gate region/structure includes a gate electrode electrically connected, e.g., tied-off, to one or more features, e.g., a power rail or other metal segment or an adjacent instance of a S/D region/structure such that a transistor corresponding to the dummy gate region/structure and overlapping/underlying active region/area is switched off by design. In some embodiments, a dummy gate region/structure that overlaps/overlies an edge of an active region/area is referred to as a continuous poly on oxide definition edge (CPODE) region/structure.

In some embodiments, an isolation region/structure, e.g., isolation region/structure ISO, includes a gate dielectric layer and/or one or more other dielectric layers and is thereby configured as an insulation layer capable of electrically isolating adjacent S/D structures, MD segments, or other conductive features from each other.

A cut-gate region, e.g., a cut-gate region CPO, also referred to as a cut-poly region in some embodiments, is a region in the IC layout diagram included in the manufacturing process as part of defining a discontinuity in a given gate structure, e.g., a portion etched away after the gate electrode has been formed, thereby resulting in adjacent and aligned gate electrode segments electrically isolated from each other. The cut-gate region can be a cut-metal gate (CMG) isolation, which is referring to that the cut-gate region is formed after metal gate formation.

A metal line or region, e.g., a frontside metal region/segment M0, a backside metal region/segment BM0, or power rail or line VDD or VSS, is a region in the IC layout diagram included in the manufacturing process as part of defining a metal line, or segment, including one or more conductive materials, e.g., polysilicon, copper (Cu), aluminum (Al), tungsten (W), cobalt (Co), ruthenium (Ru), or one or more other metals or other suitable materials, in a given frontside or backside metal layer of the manufacturing process.

In some embodiments, a metal region/segment, e.g., metal region/segment M0, corresponds to a first, or lowermost, frontside metal layer (also referred to as a metal zero layer or frontside metal zero layer in some embodiments), or a second or higher level frontside metal layer of the manufacturing process. In some embodiments, a second frontside metal layer is referred to as a metal one layer or frontside metal one layer and a second frontside metal region/segment, e.g., metal region /egment M1, is referred to as a metal one region/segment.

In some embodiments, a backside metal region/segment, e.g., metal region/segment BM0, corresponds to a first, or lowermost, backside metal layer (also referred to as a backside metal zero layer in some embodiments), or a second or higher level backside metal layer of the manufacturing process.

In some embodiments, a metal region/segment, e.g., power rail or line VDD or VSS, corresponds to a component of a power distribution network configured to distribute one or both of a power supply voltage, e.g., a power supply voltage VDD, and a reference or ground voltage, e.g., reference voltage VSS. The power distribution network component is electrically connected to one or more features, e.g., additional metal regions/segments and/or via regions/structures, configured to distribute the corresponding power supply or reference voltage and be electrically isolated from IC components outside the distribution network.

A via region/structure, e.g., a via region/structure VD or BVD or interconnect region/structure VLI, also referred to as a via or interconnect in some embodiments, is a region in the IC layout diagram included in the manufacturing process as part of defining a via/interconnect structure including one or more conductive materials configured to provide an electrical connection between a first, e.g., overlying, conductive structure, e.g., a metal segment M0, backside metal segment BM0, or power rail or line VDD or VSS, and a second, e.g., underlying, conductive structure, e.g., a metal segment, a gate electrode of a gate structure G, an instance of MD segment MD, an interconnect structure VLI, or a S/D structure SD, aligned with the first conductive structure in the Z direction.

In some embodiments, a via region/structure VD and/or backside via region/structure BVD corresponds to the underlying conductive structure being a S/D region/structure SD, MD region/segment MD, or interconnect region/structure VLI.

In some embodiments, an interconnect region/structure VLI, also referred to as a local interconnect region/structure VLI or vertical local interconnect region/structure VLI in some embodiments, corresponds to each of the underlying or overlying conductive structures being one or more instances of an MD region/segment MD, a frontside via region/structure VD, or a backside via region/structure BVD.

FIG. 1A includes a plan view and block diagram of IC layout diagram/device 100 and X and Y directions, and FIGS. 1B and 1C include cross-sectional views of IC layout diagram/device 100 along respective lines A-A′ and B-B′ of FIG. 1A, the Y direction and a Z direction. Each of FIGS. 2 and 3 includes a plan view and block diagram of the respective IC layout diagram/device 200 or 300 and the X and Y directions. FIG. 4A includes a plan view and block diagram of IC layout diagram/device 400 and the X and Y directions, and FIG. 4B includes a cross-sectional view of IC layout diagram/device 400 along line C-C′ of FIG. 4A and the Y and Z directions, In some cases, for the purpose of clarity, not all instances of each feature included IC layout diagrams/devices 100-400 are labeled in FIGS. 1A-4B.

As depicted in FIGS. 1B, 1C, and 4B, IC layout diagrams/devices 100-400 correspond to instances of a stacked CFET TU/TL having nanosheet configurations and including an upper transistor TU and a lower transistor TL. Upper transistor TU is positioned further along a positive Z direction than lower transistor TL. In various embodiments, upper transistor TU includes an n-type transistor and lower transistor TL includes a p-type transistor, or upper transistor TU includes a p-type transistor and lower transistor TL includes an n-type transistor.

IC layout diagrams/devices including the configurations discussed below corresponding to other transistor types, e.g., fin field-effect transistors (FinFETs) or planar transistors, are within the scope of the present disclosure.

As depicted in FIGS. 1A-4B, each of IC layout diagrams/devices 100-400 includes one or more instances of cells C1-6 as further discussed below. A given cell instance corresponds to an IC layout diagram configured to be stored in a storage device, e.g., a cell library such as cell library 707 discussed below with respect to IC layout diagram generation system 700, that at least partially defines an IC structure or device within a corresponding area of an IC manufactured based on the cell. In some embodiments, an IC structure or device corresponding to a cell C1-C6 is referred to as a circuit C1-C6.

In some embodiments, a cell includes opposing border segments, e.g., opposing segments of a cell border CB of a cell C1-C6, that include instances of isolation region ISO, and the IC device based on the cell includes the area between the corresponding isolation structures ISO. As depicted in FIGS. 1A-4B, the instances of cell border CB (dashed lines) of cells C1-C6 correspond to cell heights CH and cell widths CW as further discussed below.

The features within a given cell C1-C6 are configured in accordance with one or more electrical functions, e.g., an active switching or logic function or passive connecting or loading function, of an IC device manufactured based on the IC layout diagram. As depicted in FIGS. 1A-4B, cell C1 includes instances of stacked CFET transistor TU/TL configured to perform an active electrical function, each of cells C2 and C3 includes a conductive structure including an instance of interconnect region/structure VLI configured to provide an electrical connection between frontside and backside vias VD/BVD and/or metal lines M0/BM0, and each of cells C4-C6 includes one or more of the instances of stacked CFET transistor TU/TL configured to perform the active electrical function and one or more instances of the conductive structure including interconnect region/structure VLI.

In some embodiments, one or more of cells C1 or C4-C6 is a clock cell including the instances of stacked CFET transistor TU/TL configured as a corresponding clock circuit C1 or C4-C6. In some embodiments, a clock cell/circuit C1 or C4-C6 is included in a clock distribution circuit, e.g., a clock tree. In some embodiments, a clock cell/circuit C1 or C4-C6 is referred to as a high driving clock cell/circuit.

The instances of stacked CFET transistor TU/TL included in each of cells/circuits C1 and C4-C6 include corresponding instances of gate region/structure G and MD region/segment MD extending in the Y direction (cell height CH direction) across an instance of active region/area AA and positioned between instances of isolation region/structure ISO along the X direction (cell width CW direction).

The instances of interconnect region/structure VLI included in cells/circuits C2-C6 are positioned adjacent to the corresponding instances of stacked CFET transistor TU/TL in the Y direction such that corresponding gate regions/structures G are aligned with the corresponding interconnect region/structure VLI in the Y direction. As depicted in FIGS. 1A and 2-4A, cells C2-C6 include instances of cut gate CPO that surround the corresponding instances of interconnect region/structure VLI and are thereby configured to electrically isolate the corresponding instances of interconnect region/structure VLI from adjacent features including the corresponding adjacent instances of gate region/structure G.

In some embodiments, an instance of interconnect region/structure VLI extends across the width CW of the corresponding cell C2-C6 such that an entirety of the corresponding instances of gate region/structure G are aligned with the instance of interconnect region/structure VLI in the Y direction. In some embodiments, an instance of interconnect region/structure VLI extends across the width CW of the corresponding cell C2-C6 such that fewer than an entirety of the corresponding instances of gate region/structure G are aligned with the instance of interconnect region/structure VLI in the Y direction, e.g., all but one or both outermost instances of the corresponding instances of gate region/structure G along the X direction.

The numbers and orientations of cells C1-C6 and widths and numbers of gate regions structures G of cells C1-C6 depicted in FIGS. 1A-4B are non-limiting examples provided for the purpose of illustration. Numbers and orientations of cells C1-C6 and widths and numbers of gate regions/structures G other than those depicted in FIGS. 1A-4B are with the scope of the present disclosure.

As depicted in FIGS. 1A-1C, IC layout diagram 100 includes an instance of cell/circuit C1 adjacent to cell/circuit C2 in the Y direction and an instance of cell/circuit C1 adjacent to cell/circuit C3 in the Y direction. In some embodiments, IC layout diagram 100 does not include either the instance of cell/circuit C1 and adjacent cell/circuit C2 or the instance of cell/circuit C1 and adjacent cell/circuit C3.

Each of cells C1-C3, referred to as a single cell height cell C1-C3 in some embodiments, has cell height CH corresponding to a pitch (not labeled) of each of backside power supply voltage line VDD and frontside reference voltage line VSS.

As depicted in FIGS. 1B and 1C, cell/circuit C1 includes an instance of stacked CFET TU/TL including an instance of MD region/structure MD that extends in the Y direction up to the adjacent cell/circuit C2 or C3, and the adjacent cell/circuit C2 or C3 includes a corresponding instance of MD region/structure MD. Cell C1 and the adjacent cell C2 or C3 include the corresponding instances of MD region MD abutting each other such that the MD segment MD of the corresponding circuit C2 or C3 is a continuous conductive structure.

In some embodiments, the abutting MD regions and continuous conductive structure are referred to as an MD region/segment MD and the instance of MD region/segment MD in circuit C2 or C3 is referred to as a portion of the MD region/segment MD.

In some embodiments, the instances of gate region/structure G in cell/circuit C1 are considered to extend from a first location along the Y direction to a second location along the Y direction, and the MD region/segment MD is considered to extend from the first location to a third location further along the Y direction than the second location, the portion of the MD region/segment MD in cell/circuit C2 or C3 being between the second and third locations.

Each of cells/circuits C2 and C3 includes interconnect region/structure VLI extending in the Z direction and aligned in the Z direction with the portion of MD region/segment MD, a frontside via region/structure VD, a frontside metal region/line VSS in lowermost frontside layer M0, a backside via region/structure BVD, and a backside metal region/line VSS in lowermost backside metal layer BM0.

In some embodiments, one or more of a frontside via region/structure VD, a frontside metal region/line VSS, a backside via region/structure BVD, or a backside metal region/line VSS is not included in a cell/circuit, e.g., cell/circuit C2 or C3, and is instead included in a metal interconnect structure, e.g., a MEOL or BEOL structure.

The portion of MD region/segment MD, interconnect region/structure VLI, frontside via region/structure VD, and backside via region/structure BVD are thereby configured as a conductive structure extending between and electrically connected to frontside metal region/line VSS and backside metal region/line VSS. In some embodiments, the conductive structure extends between and is electrically connected to a frontside metal region/line VDD and a backside metal region/line VDD. In some embodiments, the conductive structure is referred to as a power pickup or an embedded power pickup.

In the embodiment depicted in FIGS. 1A-1C, each conductive structure extends in the Z direction such that the features included in the conductive structure are aligned in the Z direction. In some embodiments, one or more features of a given conductive structure are not aligned in the Z direction with one or more other features of the conductive structure, e.g., a frontside via VD and metal line VSS not being aligned with a backside via BVD and metal line VSS in the Z direction.

In the embodiment depicted in FIGS. 1A-1C, the instance of stacked CFET TU/TL in cell/circuit C1 includes transistor TU configured as an n-type transistor including MD region/segment MD configured as a reference voltage connection of cell/circuit C1, and the conductive structure includes MD segment MD overlying interconnect region/structure VLI, frontside via region structure VD adjacent to MD structure MD, and backside via region/structure BVD adjacent to interconnect region/structure VLI.

In some embodiments, an instance of stacked CFET TU/TL and an adjacent conductive structure are otherwise configured, e.g., by the MD segment MD corresponding to the MD portion being included in transistor TL instead of transistor TU and/or being configured as a power supply voltage VDD connection of the cell/circuit instead of the reference voltage connection. In some embodiments, the conductive structure includes interconnect region/structure VLI overlying MD segment MD, frontside via region structure VD adjacent to interconnect region/structure VLI, and backside via region/structure BVD adjacent to MD structure MD.

As depicted in FIGS. 1A and 1B, in addition to the instance of interconnect region/structure VLI, cell/circuit C2 includes a CFET electrically isolated from adjacent features, also referred to as a dummy CFET in some embodiments. The instance of interconnect region/structure VLI is positioned between cell/circuit C1 and the dummy CFET, the combination of the instance of interconnect region/structure VLI and the dummy CFET extending across cell height CH. In some embodiments, by including the dummy CFET in cell C2 adjacent to cell C1, loading uniformity of one or more manufacturing processes used to fabricate one or more instances of stacked CFET transistor TU/TL, e.g., included in circuit C1, is improved such that uniformity of the corresponding CFET features is improved compared to embodiments in which the dummy CFET is not included, e.g., cell C3 discussed below.

As depicted in FIGS. 1A and 1C, cell/circuit C3 does not include a dummy CFET, and the instance of interconnect region/structure VLI extends across cell height CH. In some embodiments, by including interconnect region/structure VLI extending across cell height CH, cell C3 is capable of including interconnect region/structure VLI having a smaller resistance compared to embodiments in which interconnect region/structure VLI does not extend across cell height CH, e.g., cell C2 discussed above.

In addition to the electrical connections provided by cell/circuit C2 or C3, cell/circuit C1 includes one or more instances of frontside via region/structure VD, e.g., electrically connected to the corresponding instance of MD region/segment MD and to an additional frontside metal line VSS, and one or more instances of backside via region/structure BVD, e.g., electrically connected to an additional instance of MD region/segment MD and a backside metal line VDD.

As discussed above, IC layout diagram/device 100 includes cells/circuits C1/C2 and/or C1/C3 configured to include stacked CFETs TU/TL including gate regions/structures G and MD regions/segments MD arranged between isolation regions/structures ISO and including an MD region/segment MD including a portion configured as a reference voltage connection to both frontside and backside conductive lines VSS through an adjacent conductive structure including interconnect region/structure VLI. Interconnect region/structure VLI is aligned with some or all of gate regions/structures G of cell/circuit C1 and positioned in one of cells C2 or C3 adjacent to cell/circuit C1, configured as a clock cell/circuit in some embodiments.

The adjacent conductive structure including interconnect region/structure VLI is capable of providing a low resistance reference voltage connection from the frontside and backside conductive lines VSS to cell/circuit C1 such that, compared to other approaches, e.g., those that do not include adjacent conductive structures, voltage drops based on current flow are reduced, thereby enabling higher current operations, e.g., high driving clock cell applications.

As depicted in FIGS. 2-4B, each of IC layout diagrams/devices 200-400 includes features arranged as discussed above with respect to FIGS. 1A-1C, except that both the circuit including stacked CFETs TU/TL and the adjacent conductive structure including interconnect region/structure VLI are included in a single corresponding cell/circuit C4-C6 instead of being included in separate cells/circuits C1/C2 or C1/C3.

In the embodiment depicted in FIG. 2, IC layout diagram/device 200 includes cell/circuit C4 having a cell height equal to twice cell height CH of cells/circuits C1-C3 discussed above. Cell/circuit C4, referred to as a double height cell in some embodiments, includes both the instance of interconnect region/structure VLI and the instances of stacked CFETs TU/TL positioned between two instances of isolation region/structure ISO.

In the embodiment depicted in FIG. 3, IC layout diagram/device 300 includes one or more instances of cell/circuit C5 having a cell height CH5 equal to 1.5 times cell height CH of cells/circuits C1-C3 discussed above. Cell/circuit C5 includes both the instance of interconnect region/structure VLI and the instances of stacked CFETs TU/TL positioned between two instances of isolation region/structure ISO. In some embodiments, instances of cell/circuit C5 are positioned adjacent to each other in the Y direction such that a sum of the two cell heights CH5 is equal to three times cell height CH.

In some embodiments, as depicted in FIG. 3, the adjacent instances of cell/circuit C5 have opposite orientations with respect to the Y direction such that instances of interconnect region VLI abut at a shared cell border, thereby defining a single interconnect structure VLI shared by the instances of stacked CFETs TU/TL in the adjacent instances of cell/circuit C5.

In the embodiment depicted in FIGS. 4A and 4B, IC layout diagram/device 400 includes cell/circuit C6 having a cell height equal to three times cell height CH of cells/circuits C1-C3 discussed above. Cell/circuit C6, referred to as a triple height cell in some embodiments, includes a single instance of stacked CFETs TU/TL positioned between two instances of interconnect region/structure VLI, the instance of stacked CFETs TU/TL and two instances of interconnect region/structure VLI being positioned between two instances of isolation region/structure ISO.

As depicted in FIGS. 4A and 4B, a single instance of MD region/segment MD is thereby configured to be included in two adjacent conductive structures including instances of interconnect region/structure VLI.

Each of IC layout diagrams/devices 200-400 is thereby configured as discussed above to include the corresponding cell/circuit C4-C6 including one or more instances of stacked CFETs TU/TL including gate regions/structures G and MD regions/segments MD arranged between isolation regions/structures ISO and including an MD region/segment MD including a portion configured as a reference voltage connection to both frontside and backside conductive lines VSS through one or more adjacent conductive structures including instances of interconnect region/structure VLI. The one or more instances of interconnect region/structure VLI are aligned with some or all of the adjacent instances of gate regions/structures G such that each of IC layout diagrams/devices 200-400 including one or more instances of the corresponding cell/circuit C4-C6 is capable of realizing the benefits discussed above with respect to IC layout diagram/device 100.

FIG. 5 is a flowchart of method 500 of manufacturing an IC device, in accordance with some embodiments. Method 500 is operable to form some or all of one or more of IC devices 100-400 discussed above with respect to FIGS. 1A-4B.

In some embodiments, performing some or all of the operations of method 500 is part of building a plurality of IC devices, e.g., transistors, logic gates, memory cells, interconnect structures, and/or other suitable devices, by performing a plurality of manufacturing operations, e.g., one or more of a lithography, diffusion, deposition, etching, planarizing, or other operation suitable for building the plurality of IC devices in a semiconductor substrate.

In some embodiments, the operations of method 500 are performed in the order depicted in FIG. 5. In some embodiments, the operations of method 500 are performed in an order other than the order depicted in FIG. 5. In some embodiments, one or more additional operations are performed before, during, and/or after the operations of method 500. In some embodiments, performing some or all of the operations of method 500 includes performing one or more operations as discussed below with respect to IC manufacturing system 800 and FIG. 8.

At operation 502, in some embodiments, a plurality of stacked CFETs is constructed by forming gate structures and MD segments between first and second isolation structures, an MD segment being aligned with an interconnect structure and configured as a reference voltage connection. Forming the gates includes forming the gates and the first and second isolation structures extending in a first direction and between the first and second isolation structures in a second direction perpendicular to the first direction. Forming the MD segment aligned with the interconnect structure includes forming the MD segment aligned with the interconnect structure in a third direction perpendicular to the first and second directions.

In some embodiments, constructing the plurality of stacked CFETs includes constructing instances of stacked CFETs TU/TL by forming gate structures G and MD segments MD between instances of isolation structures ISO and including an MD segment MD configured as a reference voltage connection and including a portion aligned with an instance of interconnect structure VLI discussed above with respect to IC layout devices 100-400 and FIGS. 1A-4B.

Constructing the plurality of stacked CFETs includes configuring the plurality of stacked CFETs in accordance with one or more electrical functions, e.g., corresponding to cells/circuits C1 and/or C4-C6 discussed above with respect to FIGS. 1A-4B. In some embodiments, constructing the plurality of stacked CFETs includes configuring the plurality of stacked CFETs as a clock circuit.

Forming the MD segment aligned with the interconnect structure includes forming the interconnect structure. In some embodiments, forming the interconnect structure includes forming the interconnect structure between the first and second isolation structures.

In some embodiments, forming the first and second isolation structures includes forming third and fourth isolation structures extending in parallel in the first direction in the front side of the semiconductor substrate and aligned with the first and second isolation structures, and forming the interconnect structure includes forming the interconnect structure between the third and fourth isolation structures.

Constructing the plurality of stacked CFETs by forming the gate structures and MD segments includes performing a plurality of manufacturing processes including one or more of a lithography, diffusion, implantation, deposition, plasma treatment, etching, planarizing, spin coating, soft-baking, exposure, post-baking, developing, rinsing, drying, or other suitable operation.

At operation 504, a frontside via is formed on one of the MD segment or the interconnect structure, and a frontside conductive line is formed on the frontside via. Forming the frontside conductive line includes forming the frontside conductive line extending in the second direction.

In some embodiments, forming the frontside via and the frontside conductive line includes forming via structure VD and frontside metal line VSS discussed above with respect to IC layout devices 100-400 and FIGS. 1A-4B.

In some embodiments, forming the frontside via includes forming the frontside via on the MD segment including a frontside MD segment of an n-type transistor of the corresponding stacked CFET of the plurality of stacked CFETs.

In some embodiments, forming the frontside via includes forming a plurality of frontside vias, e.g., including the frontside via on the MD segment, and forming the frontside conductive line includes forming a plurality of frontside conductive lines on the plurality of frontside vias.

Forming the frontside via and the frontside conductive line includes performing a plurality of manufacturing operations including depositing and patterning one or more photoresist layers, performing one or more etching processes, and performing one or more deposition processes whereby one or more conductive materials are configured to form a plurality of continuous, low resistance structures.

At operation 506, a backside via is formed on the other of the MD segment or the interconnect structure, and a backside conductive line is formed on the backside via. Forming the backside conductive line includes forming the backside conductive line extending in the second direction.

In some embodiments, forming the backside via and the backside conductive line includes forming via structure BVD and backside metal line VSS discussed above with respect to IC layout devices 100-400 and FIGS. 1A-4B.

In some embodiments, forming the backside via includes forming a plurality of backside vias, e.g., including the backside via on the MD segment, and forming the backside conductive line includes forming a plurality of backside conductive lines on the plurality of backside vias.

Forming the backside via and the backside conductive line includes performing a plurality of manufacturing operations including depositing and patterning one or more photoresist layers, performing one or more etching processes, and performing one or more deposition processes whereby one or more conductive materials are configured to form a plurality of continuous, low resistance structures.

By performing some or all of the operations of method 500, an IC device is manufactured in which an interconnect structure is aligned with gate structures of an adjacent circuit including stacked CFETs positioned in an area between isolation structures, thereby enabling the realization of the benefits discussed above with respect to IC devices 100-400.

FIG. 6 is a flowchart of method 600 of generating an IC layout diagram, e.g., one or more of IC layout diagrams 100-400 discussed above with respect to FIGS. 1A-4B, in accordance with some embodiments.

In some embodiments, generating the IC layout diagram includes generating the IC layout diagram corresponding to an IC device, e.g., IC device 100-400 discussed above with respect to FIGS. 1A-4B, manufactured based on the generated IC layout diagram.

In some embodiments, some or all of method 600 is executed by a processor of a computer, e.g., a processor 702 of an IC layout diagram generation system 700, discussed below with respect to FIG. 7.

Some or all of the operations of method 600 are capable of being performed as part of a design procedure performed in a design house, e.g., a design house 820 discussed below with respect to FIG. 8.

In some embodiments, the operations of method 600 are performed in the order depicted in FIG. 6. In some embodiments, the operations of method 600 are performed simultaneously and/or in an order other than the order depicted in FIG. 6. In some embodiments, one or more operations are performed before, between, during, and/or after performing one or more operations of method 600.

At operation 602, in some embodiments, an interconnect region is extended across a width of a cell. In some embodiments, extending the interconnect region across the width of the cell includes extending interconnect region VLI across cell width CW of one or more of cells C2-C6 discussed above with respect to FIGS. 1A-4B.

At operation 604, in some embodiments, the interconnect region is overlapped with an MD region. In some embodiments, overlapping the interconnect region with the MD region includes overlapping interconnect region VLI with a portion of an MD region MD discussed above with respect to FIGS. 1A-4B.

At operation 606, in some embodiments, the interconnect region and the MD region are overlapped with each of a frontside via region and a backside via region. In some embodiments, overlapping the interconnect region and the MD region with each of the frontside via region and the backside via region includes overlapping interconnect region VLI and MD region MD with frontside via region VD and backside via region BVD discussed above with respect to FIGS. 1A-4B.

At operation 608, in some embodiments, the cell is abutted with a second cell in an IC layout diagram. In some embodiments, abutting the cell with the second cell includes abutting one or more instances of cell C2 or C3 with one or more instances of cell C1 in IC layout diagram 100 discussed above with respect to FIGS. 1A-1C.

In some embodiments, abutting the cell with the second cell includes abutting one or more instances of one or more of cells C1-C6 with one or more additional instances of one or more of cells C1-C6 in one or more of IC layout diagrams 100-400 discussed above with respect to FIGS. 1A-4B.

At operation 610, in some embodiments, the frontside via region is overlapped with a frontside metal region and the backside via region is overlapped with a backside metal region. In some embodiments, overlapping the frontside via region with the frontside metal region and the backside via region with the backside metal region includes overlapping frontside via region VD with frontside metal line VSS and backside via region BVD with backside metal line VSS discussed above with respect to FIGS. 1A-4B.

In some embodiments, overlapping the frontside via region with the frontside metal region and the backside via region with the backside metal region includes overlapping one or more additional frontside via regions with one or more additional frontside metal regions and/or overlapping one or more additional backside via regions with one or more additional backside metal regions, e.g., as discussed above with respect to FIGS. 1A-4B.

At operation 612, in some embodiments, the IC layout diagram including the cell(s) is stored in a storage device. In some embodiments, storing the IC layout diagram in the storage device includes storing one or more of cells C1-C6 or IC layout diagrams 100-400, discussed above with respect to FIGS. 1A-4B, in the storage device.

In some embodiments, storing the IC layout diagram in the storage device includes storing the IC layout diagram in a non-volatile, computer-readable memory or a database, and/or includes storing the IC layout diagram over a network. In some embodiments, storing the IC layout diagram in the storage device includes storing the IC layout diagram in cell library 707 or layout diagrams 709 and/or over network 714 of IC layout diagram generation system 700, discussed below with respect to FIG. 7.

At operation 614, in some embodiments, one or more manufacturing operations, one or more lithographic exposures, are performed based on the IC layout diagram. Non-limiting examples of performing one or more manufacturing operations, e.g., one or more lithographic exposures, based on the IC layout diagram are discussed above with respect to FIG. 5 and below with respect to FIG. 8.

By executing some or all of the operations of method 600, an IC layout diagram is generated corresponding to an IC device in which an interconnect structure is aligned with gate structures of an adjacent circuit including stacked CFETs positioned in an area between isolation structures, thereby enabling the realization of the benefits discussed above with respect to IC devices 100-400.

FIG. 7 is a block diagram of IC layout diagram generation system 700, in accordance with some embodiments. Methods described herein of designing IC layout diagrams in accordance with one or more embodiments are implementable, for example, using IC layout diagram generation system 700, in accordance with some embodiments.

In some embodiments, IC layout diagram generation system 700 is a general purpose computing device including a hardware processor 702 and a non-transitory, computer-readable storage medium 704. Storage medium 704, amongst other things, is encoded with, i.e., stores, computer program code 706, i.e., a set of executable instructions. Execution of instructions 706 by hardware processor 702 represents (at least in part) an electronic design automation (EDA) tool which implements a portion or all of a method, e.g., method 600 of generating an IC layout diagram described above with respect to FIG. 6 (hereinafter, the noted processes and/or methods).

Processor 702 is electrically coupled to computer-readable storage medium 704 via a bus 708. Processor 702 is also electrically coupled to an I/O interface 710 by bus 708. A network interface 712 is also electrically connected to processor 702 via bus 708. Network interface 712 is connected to a network 714, so that processor 702 and computer-readable storage medium 704 are capable of connecting to external elements via network 714. Processor 702 is configured to execute computer program code 706 encoded in computer-readable storage medium 704 in order to cause IC layout diagram generation system 700 to be usable for performing a portion or all of the noted processes and/or methods. In one or more embodiments, processor 702 is a central processing unit (CPU), a multi-processor, a distributed processing system, an application specific integrated circuit (ASIC), and/or a suitable processing unit.

In one or more embodiments, computer-readable storage medium 704 is an electronic, magnetic, optical, electromagnetic, infrared, and/or a semiconductor system (or apparatus or device). For example, computer-readable storage medium 704 includes a semiconductor or solid-state memory, a magnetic tape, a removable computer diskette, a random access memory (RAM), a read-only memory (ROM), a rigid magnetic disk, and/or an optical disk. In one or more embodiments using optical disks, computer-readable storage medium 704 includes a compact disk-read only memory (CD-ROM), a compact disk-read/write (CD-R/W), and/or a digital video disc (DVD).

In one or more embodiments, computer-readable storage medium 704 stores computer program code 706 configured to cause IC layout diagram generation system 700 (where such execution represents (at least in part) the EDA tool) to be usable for performing a portion or all of the noted processes and/or methods. In one or more embodiments, computer-readable storage medium 704 also stores information which facilitates performing a portion or all of the noted processes and/or methods.

In one or more embodiments, computer-readable storage medium 704 stores cell library 707 of cells including such cells as disclosed herein, e.g., memory cell 112 of IC layout diagrams 200-400 discussed above with respect to FIGS. 1-5D.

In one or more embodiments, computer-readable storage medium 704 stores layout diagrams 709 including such IC layout diagrams as disclosed herein, e.g., IC layout diagrams 100-400 discussed above with respect to FIGS. 1A-4B.

IC layout diagram generation system 700 includes I/O interface 710. I/O interface 710 is coupled to external circuitry. In one or more embodiments, I/O interface 710 includes a keyboard, keypad, mouse, trackball, trackpad, touchscreen, and/or cursor direction keys for communicating information and commands to processor 702.

IC layout diagram generation system 700 also includes network interface 712 coupled to processor 702. Network interface 712 allows system 700 to communicate with network 714, to which one or more other computer systems are connected. Network interface 712 includes wireless network interfaces such as BLUETOOTH, WIFI, WIMAX, GPRS, or WCDMA; or wired network interfaces such as ETHERNET, USB, or IEEE-1364. In one or more embodiments, a portion or all of noted processes and/or methods, is implemented in two or more IC layout diagram generation systems 700.

IC layout diagram generation system 700 is configured to receive information through I/O interface 710. The information received through I/O interface 710 includes one or more of instructions, data, design rules, libraries of standard cells, and/or other parameters for processing by processor 702. The information is transferred to processor 702 via bus 708. IC layout diagram generation system 700 is configured to receive information related to a UI through I/O interface 710. The information is stored in computer-readable medium 704 as user interface (UI) 742.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application. In some embodiments, at least one of the noted processes and/or methods is implemented as a software application that is a portion of an EDA tool. In some embodiments, a portion or all of the noted processes and/or methods is implemented as a software application that is used by IC layout diagram generation system 700. In some embodiments, a layout diagram which includes standard cells is generated using a tool such as VIRTUOSO® available from CADENCE DESIGN SYSTEMS, Inc., or another suitable layout generating tool.

In some embodiments, the processes are realized as functions of a program stored in a non-transitory computer readable recording medium. Examples of a non-transitory computer readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

FIG. 8 is a block diagram of IC manufacturing system 800, and an IC manufacturing flow associated therewith, in accordance with some embodiments. In some embodiments, based on an IC layout diagram, at least one of (A) one or more semiconductor masks or (B) at least one component in a layer of a semiconductor integrated circuit is fabricated using manufacturing system 800.

In FIG. 8, IC manufacturing system 800 includes entities, such as a design house 820, a mask house 830, and an IC manufacturer/fabricator (“fab”) 850, that interact with one another in the design, development, and manufacturing cycles and/or services related to manufacturing an IC device 860. The entities in system 800 are connected by a communications network. In some embodiments, the communications network is a single network. In some embodiments, the communications network is a variety of different networks, such as an intranet and the Internet. The communications network includes wired and/or wireless communication channels. Each entity interacts with one or more of the other entities and provides services to and/or receives services from one or more of the other entities. In some embodiments, two or more of design house 820, mask house 830, and IC fab 850 is owned by a single larger company. In some embodiments, two or more of design house 820, mask house 830, and IC fab 850 coexist in a common facility and use common resources.

Design house (or design team) 820 generates an IC design layout diagram 822. IC design layout diagram 822 includes various geometrical patterns, e.g., one or more of IC layout diagrams 100-400 discussed above with respect to FIGS. 1A-4B. The geometrical patterns correspond to patterns of metal, oxide, or semiconductor layers that make up the various components of IC device 860 to be fabricated. The various layers combine to form various IC features. For example, a portion of IC design layout diagram 822 includes various IC features, such as an active region, gate electrode, source and drain, metal lines or vias of an interlayer interconnection, and openings for bonding pads, to be formed in a semiconductor substrate (such as a silicon wafer) and various material layers disposed on the semiconductor substrate. Design house 820 implements a proper design procedure to form IC design layout diagram 822. The design procedure includes one or more of logic design, physical design or place and route. IC design layout diagram 822 is presented in one or more data files having information of the geometrical patterns. For example, IC design layout diagram 822 can be expressed in a GDSII file format or DFII file format.

Mask house 830 includes data preparation 832 and mask fabrication 844. Mask house 830 uses IC design layout diagram 822 to manufacture one or more masks 845 to be used for fabricating the various layers of IC device 860 according to IC design layout diagram 822. Mask house 830 performs mask data preparation 832, where IC design layout diagram 822 is translated into a representative data file (RDF). Mask data preparation 832 provides the RDF to mask fabrication 844. Mask fabrication 844 includes a mask writer. A mask writer converts the RDF to an image on a substrate, such as a mask (reticle) 845 or a semiconductor wafer 853. The design layout diagram 822 is manipulated by mask data preparation 832 to comply with particular characteristics of the mask writer and/or requirements of IC fab 850. In FIG. 8, mask data preparation 832 and mask fabrication 844 are illustrated as separate elements. In some embodiments, mask data preparation 832 and mask fabrication 844 can be collectively referred to as mask data preparation.

In some embodiments, mask data preparation 832 includes optical proximity correction (OPC) which uses lithography enhancement techniques to compensate for image errors, such as those that can arise from diffraction, interference, other process effects and the like. OPC adjusts IC design layout diagram 822. In some embodiments, mask data preparation 832 includes further resolution enhancement techniques (RET), such as off-axis illumination, sub-resolution assist features, phase-shifting masks, other suitable techniques, and the like or combinations thereof. In some embodiments, inverse lithography technology (ILT) is also used, which treats OPC as an inverse imaging problem.

In some embodiments, mask data preparation 832 includes a mask rule checker (MRC) that checks the IC design layout diagram 822 that has undergone processes in OPC with a set of mask creation rules which contain certain geometric and/or connectivity restrictions to ensure sufficient margins, to account for variability in semiconductor manufacturing processes, and the like. In some embodiments, the MRC modifies the IC design layout diagram 822 to compensate for limitations during mask fabrication 844, which may undo part of the modifications performed by OPC in order to meet mask creation rules.

In some embodiments, mask data preparation 832 includes lithography process checking (LPC) that simulates processing that will be implemented by IC fab 850 to fabricate IC device 860. LPC simulates this processing based on IC design layout diagram 822 to create a simulated manufactured device, such as IC device 860. The processing parameters in LPC simulation can include parameters associated with various processes of the IC manufacturing cycle, parameters associated with tools used for manufacturing the IC, and/or other aspects of the manufacturing process. LPC takes into account various factors, such as aerial image contrast, depth of focus (“DOF”), mask error enhancement factor (“MEEF”), other suitable factors, and the like or combinations thereof. In some embodiments, after a simulated manufactured device has been created by LPC, if the simulated device is not close enough in shape to satisfy design rules, OPC and/or MRC are be repeated to further refine IC design layout diagram 822.

It should be understood that the above description of mask data preparation 832 has been simplified for the purposes of clarity. In some embodiments, data preparation 832 includes additional features such as a logic operation (LOP) to modify the IC design layout diagram 822 according to manufacturing rules. Additionally, the processes applied to IC design layout diagram 822 during data preparation 832 may be executed in a variety of different orders.

After mask data preparation 832 and during mask fabrication 844, a mask 845 or a group of masks 845 are fabricated based on the modified IC design layout diagram 822. In some embodiments, mask fabrication 844 includes performing one or more lithographic exposures based on IC design layout diagram 822. In some embodiments, an electron-beam (e-beam) or a mechanism of multiple e-beams is used to form a pattern on a mask (photomask or reticle) 845 based on the modified IC design layout diagram 822. Mask 845 can be formed in various technologies. In some embodiments, mask 845 is formed using binary technology. In some embodiments, a mask pattern includes opaque regions and transparent regions. A radiation beam, such as an ultraviolet (UV) or EUV beam, used to expose the image sensitive material layer (e.g., photoresist) which has been coated on a wafer, is blocked by the opaque region and transmits through the transparent regions. In one example, a binary mask version of mask 845 includes a transparent substrate (e.g., fused quartz) and an opaque material (e.g., chromium) coated in the opaque regions of the binary mask. In another example, mask 845 is formed using a phase shift technology. In a phase shift mask (PSM) version of mask 845, various features in the pattern formed on the phase shift mask are configured to have proper phase difference to enhance the resolution and imaging quality. In various examples, the phase shift mask can be attenuated PSM or alternating PSM. The mask(s) generated by mask fabrication 844 is used in a variety of processes. For example, such a mask(s) is used in an ion implantation process to form various doped regions in semiconductor wafer 853, in an etching process to form various etching regions in semiconductor wafer 853, and/or in other suitable processes.

IC fab 850 is an IC fabrication business that includes one or more manufacturing facilities for the fabrication of a variety of different IC products. In some embodiments, IC Fab 850 is a semiconductor foundry. For example, there may be a manufacturing facility for the front end fabrication of a plurality of IC products (front-end-of-line (FEOL) fabrication), while a second manufacturing facility may provide the back end fabrication for the interconnection and packaging of the IC products (back-end-of-line (BEOL) fabrication), and a third manufacturing facility may provide other services for the foundry business.

IC fab 850 includes wafer fabrication tools 852 configured to execute various manufacturing operations on semiconductor wafer 853 such that IC device 860 is fabricated in accordance with the mask(s), e.g., mask 845. In various embodiments, fabrication tools 852 include one or more of a wafer stepper, an ion implanter, a photoresist coater, a process chamber, e.g., a CVD chamber or LPCVD furnace, a CMP system, a plasma etch system, a wafer cleaning system, or other manufacturing equipment capable of performing one or more suitable manufacturing processes as discussed herein.

IC fab 850 uses mask(s) 845 fabricated by mask house 830 to fabricate IC device 860. Thus, IC fab 850 at least indirectly uses IC design layout diagram 822 to fabricate IC device 860. In some embodiments, semiconductor wafer 853 is fabricated by IC fab 850 using mask(s) 845 to form IC device 860. In some embodiments, the IC fabrication includes performing one or more lithographic exposures based at least indirectly on IC design layout diagram 822. Semiconductor wafer 853 includes a silicon substrate or other proper substrate having material layers formed thereon. Semiconductor wafer 853 further includes one or more of various doped regions, dielectric features, multilevel interconnects, and the like (formed at subsequent manufacturing steps).

In some embodiments, an IC device includes first and second isolation structures extending in parallel in a first direction in a front side of a semiconductor substrate, a circuit including a plurality of stacked CFETs including pluralities of gates and MD segments extending in the first direction between the first and second isolation structures, wherein each gate of the plurality of gates extends from a first location along the first direction to a second location along the first direction and an MD segment of the plurality of MD segments is configured as a reference voltage connection of the circuit and extends from the first location to a third location further along the first direction than the second location, a first conductive line extending in a second direction perpendicular to the first direction on the front side of the semiconductor substrate, a second conductive line extending in the second direction on a back side of the semiconductor substrate, and a conductive structure extending from the first conductive line to the second conductive line along a third direction perpendicular to each of the first and second directions, wherein the conductive structure includes a portion of the MD segment between the second and third locations. In some embodiments, the conductive structure includes an interconnect structure adjacent to the portion of the MD segment along the third direction, a frontside via extending from the first conductive line to one of the MD segment or the interconnect structure, and a backside via extending from the second conductive line to the other of the MD segment or the interconnect structure. In some embodiments, each gate of the plurality of gates is aligned with the interconnect structure along the first direction. In some embodiments, the MD segment of the plurality of MD segments includes a frontside MD segment of an n-type transistor of the corresponding stacked CFET of the plurality of stacked CFETs. In some embodiments, the IC device includes a third conductive line extending in the second direction on the front side of the semiconductor substrate and a frontside via extending from the third conductive line to the MD segment. In some embodiments, the IC device includes third and fourth isolation structures extending in parallel in the first direction in the front side of the semiconductor substrate and aligned with the first and second isolation structures, wherein the conductive structure is positioned between the third and fourth isolation structures. In some embodiments, the IC device includes a dummy stacked CFET positioned between the third and fourth isolation structures, wherein the conductive structure is positioned between the dummy stacked CFET and the stacked CFET including the MD segment. In some embodiments, the conductive structure is positioned between the first and second isolation structures. In some embodiments, the circuit is a first circuit including the plurality of stacked CFETs being a first plurality of stacked CFETs including the pluralities of gates and MD segments being first pluralities of gates and MD segments, the IC device includes third and fourth isolation structures extending in parallel in the first direction in the front side of the semiconductor substrate and aligned with the first and second isolation structures and a second circuit positioned between the third and fourth isolation structures and including a second plurality of stacked CFETs including second pluralities of gates and MD segments, the conductive structure is positioned between the first and second circuits, and the MD segment is further an MD segment of the second plurality of MD segments configured as a reference voltage connection of the second circuit. In some embodiments, the conductive structure is a first conductive structure, the MD segment further extends from the first location to a fourth location along the first direction, the first location being between the second and fourth locations, and the IC device includes a third conductive line extending in the second direction on the front side of the semiconductor substrate, a fourth conductive line extending in the second direction on the back side of the semiconductor substrate, and a second conductive structure extending from the third conductive line to the fourth conductive line and including another portion of the MD segment between the first and fourth locations. In some embodiments, the circuit includes the plurality of stacked CFETs configured as a clock circuit.

In some embodiments, a method of manufacturing an IC device includes constructing first and second isolation structures and a plurality of stacked CFETs on a front side of a semiconductor substrate, constructing the plurality of stacked CFETs including forming pluralities of gates and MD segments extending in a first direction between the first and second isolation structures in a second direction perpendicular to the first direction and forming an interconnect structure adjacent to and aligned with the plurality of gates in the first direction, wherein a portion of an MD segment of the plurality of MD segments is aligned with the interconnect structure in a third direction perpendicular to each of the first and second directions, forming a frontside via on one of the portion of the MD segment or the interconnect structure, forming a frontside conductive line on the frontside via and extending in the second direction, forming a backside via on the other of the MD segment or the interconnect structure, and forming a backside conductive line on the backside via and extending in the second direction. In some embodiments, forming the frontside via includes forming the frontside via on the portion of the MD segment including a frontside MD segment of an n-type transistor of the corresponding stacked CFET of the plurality of stacked CFETs. In some embodiments, forming the frontside via includes forming a first frontside via on the portion of the MD segment and further includes forming a second frontside via on the MD segment, and forming the frontside conductive line includes forming a first frontside conductive line on the first frontside via and further includes forming a second frontside conductive line on the second frontside via and extending in the second direction. In some embodiments, constructing the first and second isolation structures includes constructing third and fourth isolation structures extending in parallel in the first direction in the front side of the semiconductor substrate and aligned with the first and second isolation structures, and forming the interconnect structure includes forming the interconnect structure between the third and fourth isolation structures. In some embodiments, constructing the plurality of stacked CFETs includes configuring the plurality of stacked CFETs as a clock circuit including the MD segment configured as a reference voltage connection.

In some embodiments, a method of method of generating an IC layout diagram includes extending an interconnect region across a width of a cell, overlapping the interconnect region with an MD region, overlapping the interconnect region and the MD region with a frontside via region and a backside via region, overlapping the frontside via region with a frontside metal region and the backside via region with a backside metal region, each of the frontside and backside metal regions extending in a cell width direction, and storing the IC layout diagram comprising the cell in a storage device. In some embodiments, the cell is a first cell, the MD region is a first MD region, the method includes abutting the first cell with a second cell including a plurality of stacked CFETs including pluralities of gate regions and MD regions, and abutting the first cell with the second cell includes aligning the plurality of gate regions with the interconnect region along a cell height direction and abutting a second MD region of the plurality of MD regions with the first MD region. In some embodiments, the method includes arranging pluralities of gate regions and MD regions of a plurality of stacked CFETs in the cell, wherein arranging the plurality of gate regions includes aligning the plurality of gate regions with the interconnect region along a cell height direction and arranging the plurality of MD regions includes including the MD region in a corresponding stacked CFET of the plurality of stacked CFETs. In some embodiments, overlapping the frontside via region with the frontside metal region and the backside via region with the backside metal region includes configuring each of the frontside metal region and the backside metal region as part of a reference voltage distribution grid.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An integrated circuit (IC) device comprising:
first and second isolation structures extending in parallel in a first direction in a front side of a semiconductor substrate;
a circuit comprising a plurality of stacked complementary field-effect transistors (CFETs) comprising pluralities of gates and metal-like defined (MD) segments extending in the first direction between the first and second isolation structures, wherein
each gate of the plurality of gates extends from a first location along the first direction to a second location along the first direction, and
an MD segment of the plurality of MD segments is configured as a reference voltage connection of the circuit and extends from the first location to a third location further along the first direction than the second location;
a first conductive line extending in a second direction perpendicular to the first direction on the front side of the semiconductor substrate;
a second conductive line extending in the second direction on a back side of the semiconductor substrate; and
a conductive structure extending from the first conductive line to the second conductive line along a third direction perpendicular to each of the first and second directions,
wherein the conductive structure comprises a portion of the MD segment between the second and third locations.

2. The IC device of claim 1, wherein the conductive structure further comprises:
an interconnect structure adjacent to the portion of the MD segment along the third direction;
a frontside via extending from the first conductive line to one of the MD segment or the interconnect structure; and
a backside via extending from the second conductive line to the other of the MD segment or the interconnect structure.

3. The IC device of claim 2, wherein
each gate of the plurality of gates is aligned with the interconnect structure along the first direction.

4. The IC device of claim 1, wherein
the MD segment of the plurality of MD segments comprises a frontside MD segment of an n-type transistor of the corresponding stacked CFET of the plurality of stacked CFETs.

5. The IC device of claim 1, further comprising:
a third conductive line extending in the second direction on the front side of the semiconductor substrate; and
a frontside via extending from the third conductive line to the MD segment.

6. The IC device of claim 1, further comprising:
third and fourth isolation structures extending in parallel in the first direction in the front side of the semiconductor substrate and aligned with the first and second isolation structures,
wherein the conductive structure is positioned between the third and fourth isolation structures.

7. The IC device of claim 6, further comprising:
a dummy stacked CFET positioned between the third and fourth isolation structures,
wherein the conductive structure is positioned between the dummy stacked CFET and the stacked CFET comprising the MD segment.

8. The IC device of claim 1, wherein
the conductive structure is positioned between the first and second isolation structures.

9. The IC device of claim 1, wherein
the circuit is a first circuit comprising the plurality of stacked CFETs being a first plurality of stacked CFETs comprising the pluralities of gates and MD segments being first pluralities of gates and MD segments,
the IC device further comprises:
third and fourth isolation structures extending in parallel in the first direction in the front side of the semiconductor substrate and aligned with the first and second isolation structures; and
a second circuit positioned between the third and fourth isolation structures and comprising a second plurality of stacked CFETs comprising second pluralities of gates and MD segments,
the conductive structure is positioned between the first and second circuits, and
the MD segment is further an MD segment of the second plurality of MD segments configured as a reference voltage connection of the second circuit.

10. The IC device of claim 1, wherein
the conductive structure is a first conductive structure,
the MD segment further extends from the first location to a fourth location along the first direction, the first location being between the second and fourth locations, and
the IC device further comprises:
a third conductive line extending in the second direction on the front side of the semiconductor substrate;
a fourth conductive line extending in the second direction on the back side of the semiconductor substrate; and
a second conductive structure extending from the third conductive line to the fourth conductive line and comprising another portion of the MD segment between the first and fourth locations.

11. The IC device of claim 1, wherein
the circuit comprises the plurality of stacked CFETs configured as a clock circuit.

12. A method of manufacturing an integrated circuit (IC) device, the method comprising:
constructing first and second isolation structures and a plurality of stacked complementary field-effect transistors (CFETs) on a front side of a semiconductor substrate, the constructing the plurality of stacked CFETs comprising:
forming pluralities of gates and metal-like defined (MD) segments extending in a first direction between the first and second isolation structures in a second direction perpendicular to the first direction; and
forming an interconnect structure adjacent to and aligned with the plurality of gates in the first direction,
wherein a portion of an MD segment of the plurality of MD segments is aligned with the interconnect structure in a third direction perpendicular to each of the first and second directions;
forming a frontside via on one of the portion of the MD segment or the interconnect structure;
forming a frontside conductive line on the frontside via and extending in the second direction;
forming a backside via on the other of the MD segment or the interconnect structure; and
forming a backside conductive line on the backside via and extending in the second direction.

13. The method of claim 12, wherein
the forming the frontside via comprises forming the frontside via on the portion of the MD segment comprising a frontside MD segment of an n-type transistor of the corresponding stacked CFET of the plurality of stacked CFETs.

14. The method of claim 12, wherein
the forming the frontside via comprises forming a first frontside via on the portion of the MD segment and further comprises forming a second frontside via on the MD segment, and
the forming the frontside conductive line comprises forming a first frontside conductive line on the first frontside via and further comprises forming a second frontside conductive line on the second frontside via and extending in the second direction.

15. The method of claim 12, wherein
the constructing the first and second isolation structures comprises constructing third and fourth isolation structures extending in parallel in the first direction in the front side of the semiconductor substrate and aligned with the first and second isolation structures, and
the forming the interconnect structure comprises forming the interconnect structure between the third and fourth isolation structures.

16. The method of claim 12, wherein
the constructing the plurality of stacked CFETs comprises configuring the plurality of stacked CFETs as a clock circuit including the MD segment configured as a reference voltage connection.

17. A method of generating an integrated circuit (IC) layout diagram, the method comprising:
extending an interconnect region across a width of a cell;
overlapping the interconnect region with a metal-like defined (MD) region;
overlapping the interconnect region and the MD region with a frontside via region and a backside via region;
overlapping the frontside via region with a frontside metal region and the backside via region with a backside metal region, each of the frontside and backside metal regions extending in a cell width direction; and
storing the IC layout diagram comprising the cell in a storage device.

18. The method of claim 17, wherein
the cell is a first cell,
the MD region is a first MD region,
the method further comprises abutting the first cell with a second cell comprising a plurality of stacked complementary field-effect transistors (CFETs) comprising pluralities of gate regions and MD regions, and
the abutting the first cell with the second cell comprises:
aligning the plurality of gate regions with the interconnect region along a cell height direction; and
abutting a second MD region of the plurality of MD regions with the first MD region.

19. The method of claim 17, further comprising:
arranging pluralities of gate regions and MD regions of a plurality of stacked complementary field-effect transistors (CFETs) in the cell, wherein
the arranging the plurality of gate regions comprises aligning the plurality of gate regions with the interconnect region along a cell height direction, and
the arranging the plurality of MD regions comprises including the MD region in a corresponding stacked CFET of the plurality of stacked CFETs.

20. The method of claim 17, wherein
the overlapping the frontside via region with the frontside metal region and the backside via region with the backside metal region comprises configuring each of the frontside metal region and the backside metal region as part of a reference voltage distribution grid.
